(19) United States
(12) Patent Application Publication
(10) Pub. No.: US 2013/0285892 A1
(43) Pub. Date: Oct. 31, 2013

(54) LIQUID CRYSTAL DISPLAY PANEL AND DRIVING METHOD THEREOF, AND LIQUID CRYSTAL DISPLAY DEVICE

(71) Applicant: Shanghai Tianma Micro-Electronics Co., Ltd., Shanghai (CN)

(72) Inventors: Dong QIAN, Shanghai (CN); Hanyu GU, Shanghai (CN); Chang-ho TSENG, Shanghai (CN); Meng CUI, Shanghai (CN)

(21) Appl. No.: 13/926,925

(22) Filed: Jun. 25, 2013

Related U.S. Application Data
(63) Continuation of application No. PCT/CN2012/078221, filed on Jul. 5, 2012.

(30) Foreign Application Priority Data
Dec. 6, 2011 (CN) 201110462258.X

(51) Int. Cl. G09G 3/36

(52) U.S. Cl. CPC G09G 3/3614
USPC 345/96

(57) ABSTRACT

A Liquid Crystal Display (LCD) panel includes a pixel array, a scanning line driver, a common electrode driver, and a data line driver. During a current frame, the scanning lines receive a scanning signal. The common electrode driver applies a common electrode signal to the common electrode line during a time window in which the scanning line corresponding to the common electrode line receives the scanning signal. The data line driver applies a data signal to the data lines during a time window in which the scanning line driver outputs the scanning signal. The data signals of adjacent pixel rows have opposite polarities, the common electrode signal during the current frame is opposite to the common electrode signal during a next frame, and the data signals of the pixel row in the current frame have opposite polarities of the data signals applied on the pixel row during the next frame.

### CROSS-REFERENCES TO RELATED APPLICATIONS

The application claims priority to and is a continuation of International Patent Application PCT/CN2012/078221, titled “LIQUID CRYSTAL DISPLAY PANEL AND DRIVING METHOD THEREOF, AND LIQUID CRYSTAL DISPLAY DEVICE”, filed on Jul. 5, 2012, which claims priority to Chinese patent application No. 201110462258.X, titled “LIQUID CRYSTAL DISPLAY PANEL AND DRIVING METHOD THEREOF, AND LIQUID CRYSTAL DISPLAY DEVICE” and filed with the State Intellectual Property Office on Dec. 6, 2011, the contents of which are incorporated herein by reference in their entirety.

### FIELD OF THE INVENTION

The invention relates to the field of driving technology for a Liquid Crystal Display, and in particular to a Liquid Crystal Display panel, a driving method for the Liquid Crystal Display panel and a Liquid Crystal Display device with the Liquid Crystal Display panel.

### BACKGROUND OF THE INVENTION

Due to the generation and rapid development of smart mobile phones, a Liquid Crystal Display (LCD) screen with a large size and a high resolution is more and more popular in the market. Due to the limitation of a battery life of the mobile phone, it is important for power consumption of the LCD screen to be minimized. There are mainly three conventional driving methods for LCD screen: surface inversion, line inversion and dot inversion. FIGS. 1a to 1c are schematic diagrams showing the surface inversion, the line inversion and the dot inversion respectively. In the surface inversion and the line inversion, a voltage range of a data signal can be decreased by using an alternating current common electrode voltage (AC Vcom), so as to save power. However, due to the influence among pixels, a picture displaying quality is reduced. A better picture displaying quality can be provided by combining the dot inversion with a direct current common electrode voltage (DC Vcom), but it does not save power. The above schemes are disclosed at least in the patents or patent applications EP0558059A2, U.S. Pat. No. 6,906,692B2, CN200410101730, and US 2008136764A1.

FIG. 2 is a schematic diagram illustrating a separation type Vcom driving system in the prior art. As shown in FIG. 2, a separation type Vcom driving method (discussed in U.S. Pat. No. 6,906,692B2) is provided by Seiko Epson in 2000, so as to improve the influence caused by the line inversion combined with AC Vcom. This separation type Vcom driving method is mainly used for an In-Plane Switching (IPS) structure or an Advanced Fringe Field Switching (AFFS) structure. By using the driving method of the line inversion combined with DC Vcom, the power consumption can be reduced and a good picture displaying quality can be provided. FIGS. 3a and 3b are we form diagrams illustrating two embodiments of the above-described scheme respectively, which correspond to different driving timing sequences.

FIG. 4 shows a driving method used in a Twisted Nematic (TN) structure or a Vertical Alignment(VA) structure. In the TN or VA mode, both a TFT substrate and a CF substrate have a Vcom electrode therein. The TFT substrate adopts a Vcom separation control, and the CF substrate adopts a fixed Vcom. Those techniques also decrease the voltage range of the data signal, so as to reduce the power consumption.

The above referenced schemes respectively correspond to the IPS and AFFS displaying architectures and the TN and VA displaying architectures. Due to the different displaying architectures, the driving methods corresponding to these displaying architectures can not be shared.

### BRIEF SUMMARY OF THE INVENTION

One implementation is a Liquid Crystal Display (LCD) panel, including a pixel array including a plurality of pixels, arranged in rows and columns. The LCD panel also includes a plurality of scanning lines, where each of the scanning lines is connected to one of the rows of pixels in the pixel array. The LCD panel also includes a plurality of common electrode lines, where each of the common electrode lines is connected to one of the rows of pixels in the pixel array, and a plurality of data lines, where each of the data lines is connected to a column of pixels in the pixel array. The LCD panel also includes a scanning line driving circuit connected to the scanning lines of the pixel array and configured to apply a scanning signal to each row of pixels, a common electrode driving circuit connected to the common electrode lines of the pixel array and configured to apply a common electrode signal to each row of pixels, and a data line driving circuit connected to the data lines of the pixel array and configured to apply a data signal to each column of pixels in the pixel array. During a first scanning frame, the scanning line driving circuit sequentially applies a scanning signal to each of the scanning lines during a corresponding time window, where the common electrode driving circuit applies a common electrode signal to each common electrode line during a time window in which the scanning signal is applied to the corresponding scanning line. The common electrode signals applied to adjacent common electrode lines are opposite, and the data line driving circuit applies data signals to the plurality of data lines during a time window in which the scanning signal is applied to one of the scanning lines. The data signals applied to adjacent rows of pixels have opposite polarities, and the common electrode signal output by the common electrode line during the first scanning frame is opposite the common electrode signal output during a next scanning frame. In addition, the data signals of the row of pixels during the first scanning frame have opposite polarities to the data signals of the row of pixels during the next scanning frame.

Another implementation is a method of driving a Liquid Crystal Display (LCD), panel, where the LCD panel includes a pixel array, a plurality of scanning lines and a plurality of common electrode lines connected to rows of pixels in the pixel array, and a plurality of data lines connected to columns of pixels in the pixel array. The method includes applying a scanning signal during a (2n−1)^{th} time window of a current scanning frame to a (2n−1)^{th} scanning line, where 2n−1≦N, n is a positive integer, and the pixel array has N rows of pixels. The method also includes applying a low level common electrode signal to (2n−1)^{th} common electrode line during the (2n−1)^{th} time window, where the row of pixels connected to the (2n−1)^{th} scanning line is also connected to the (2n−1)^{th} common electrode line, applying a positive data signal to each of the plurality of data lines during the (2n−1)^{th} time window, and applying a scanning signal to a (2n′)^{th} scanning line during a (2n′)^{th} time window of the current scanning frame, where 2n′≦N, n′ is a positive integer. The method also includes applying a high level common electrode signal to a (2n′)^{th} common electrode line during the (2n′)^{th} time window, where a row of pixels connected to the (2n′)^{th} scanning line is also connected to the (2n′)^{th} common electrode line, and applying a negative data signal to each of the plurality of data lines during the (2n′)^{th} time window.

Another implementation is a method of driving a Liquid Crystal Display (LCD) panel, where the LCD panel includes a pixel array, a plurality of scanning lines and a plurality of common electrode lines connected to rows of pixels in the pixel array, and a plurality of data lines connected to columns of pixels in the pixel array. The method includes applying a scanning signal to a (2n−1)^{th} scanning line during a (2n−1)^{th} time window of a current scanning frame, where 2n−1≦N, n is a positive integer, and the pixel array has N rows of pixels. The method also includes applying a high level common electrode signal to a (2n−1)^{th} common electrode line during the (2n−1)^{th} time window, where the row of pixels connected to the (2n−1)^{th} scanning line is also connected to the (2n−1)^{th} common electrode line. The method also includes applying a negative data signal to each of the plurality of the data lines during the (2n−1)^{th} time window, and applying a scanning signal to a (2n′)^{th} scanning line during a (2n′)^{th} time window of the current scanning frame, where 2n′≦N, and n′ is a positive integer. The method also includes applying a low level common electrode signal to a (2n′)^{th} common electrode line during the (2n′)^{th} time window, where the row of pixels connected to the (2n′)^{th} scanning line is also connected to the (2n′)^{th} common electrode line, and applying a positive data signal to each of the plurality of data lines during the (2n′)^{th} time window.

Another implementation is a liquid crystal display device, including a Liquid Crystal Display (LCD) panel, which has a pixel array including a plurality of pixels, arranged in rows and columns. The LCD panel also includes a plurality of scanning lines, where each of the scanning lines is connected to one of the rows of pixels in the pixel array, a plurality of common electrode lines, where each of the common electrode lines is connected to one of the rows of pixels in the pixel array, and a plurality of data lines, where each of the data lines is connected to a column of pixels in the pixel array. The LCD panel also includes a scanning line driving circuit connected to the scanning lines of the pixel array and configured to apply a scanning signal to each row of pixels, a common electrode driving circuit connected to the common electrode lines of the pixel array and configured to apply a common electrode signal to each row of pixels, and a data line driving circuit connected to the data lines of the pixel array and configured to apply a data signal to each column of pixels in the pixel array. During a first scanning frame, the scanning line driving circuit sequentially applies a scanning signal to each of the scanning lines during a corresponding time window, and the common electrode driving circuit applies a common electrode signal to each common electrode line during a time window in which the scanning signal is applied to the corresponding scanning line. In addition, the common electrode signals applied to adjacent common electrode lines are opposite, and the data line driving circuit applies data signals to the plurality of data lines during a time window in which the scanning signal is applied to one of the scanning lines. Furthermore, the data signals applied to adjacent rows of pixels have opposite polarities, and the common electrode signal output by the common electrode line during the first scanning frame is opposite the common electrode signal output during a next scanning frame. Additionally, the data signals of the row of pixels during the first scanning frame have opposite polarities to the data signals of the row of pixels during the next scanning frame.

### BRIEF DESCRIPTION OF THE DRAWINGS

The above-described and/or additional aspects and advantages of the invention are described below with reference to the following drawings, in which:

FIGS. 1a-1c are schematic diagrams showing a surface inversion, a line inversion and a dot inversion respectively;

FIG. 2 shows a separation type Vcom driving method in the prior art;

FIG. 3a is a timing sequence diagram of a display driving module in FIG. 1;

FIG. 3b is another timing sequence diagram of a display driving module in FIG. 1;

FIG. 4 shows a driving method used in a TN structure or VA structure in the prior art;

FIG. 5 is a structural schematic diagram of an LCD panel according to an embodiment of the invention;

FIG. 6 is a timing sequence diagram of scanning lines, common electrode lines and data lines according to an embodiment of the invention; and

FIG. 7 is a flowchart of a driving method of an LCD panel according to an embodiment of the invention.

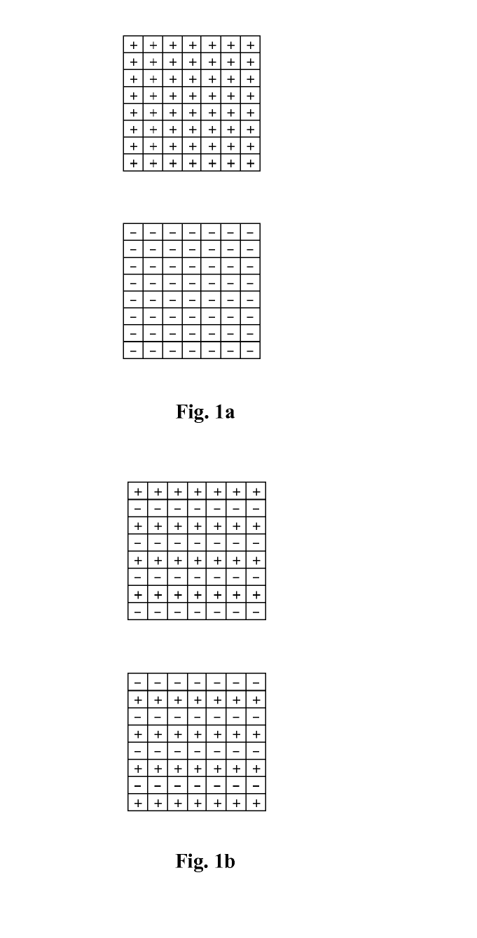

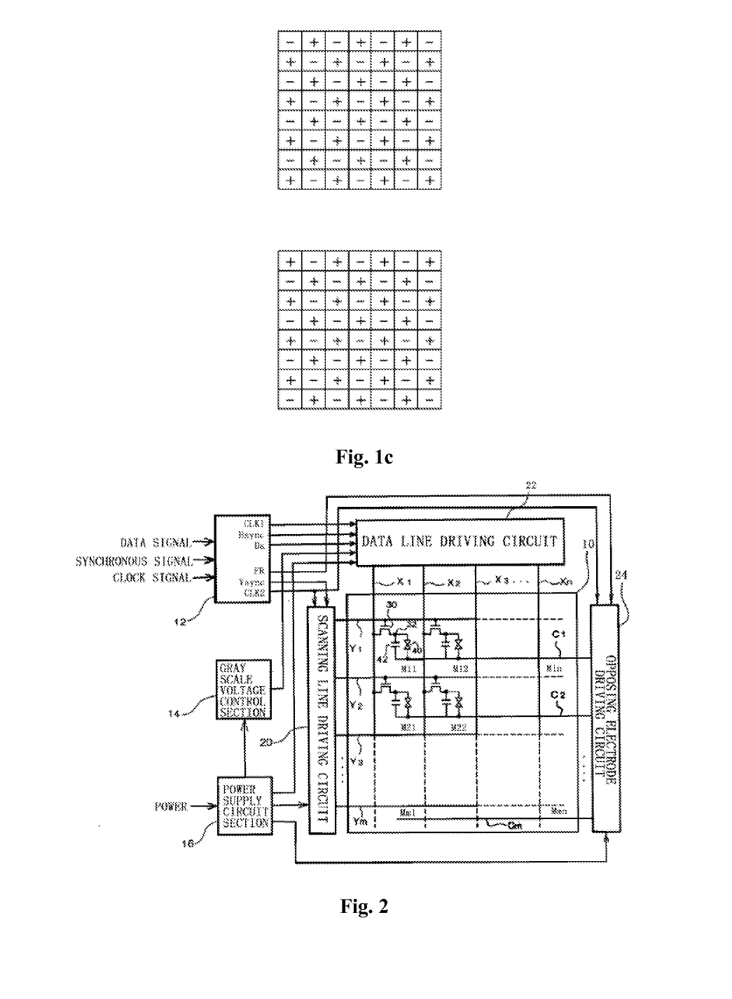

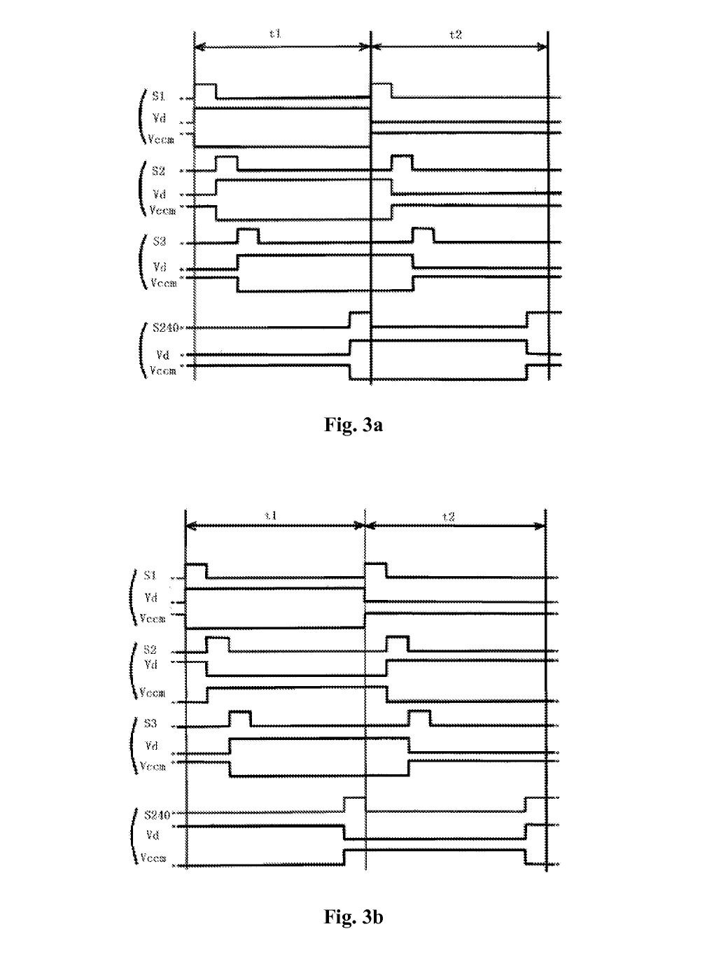

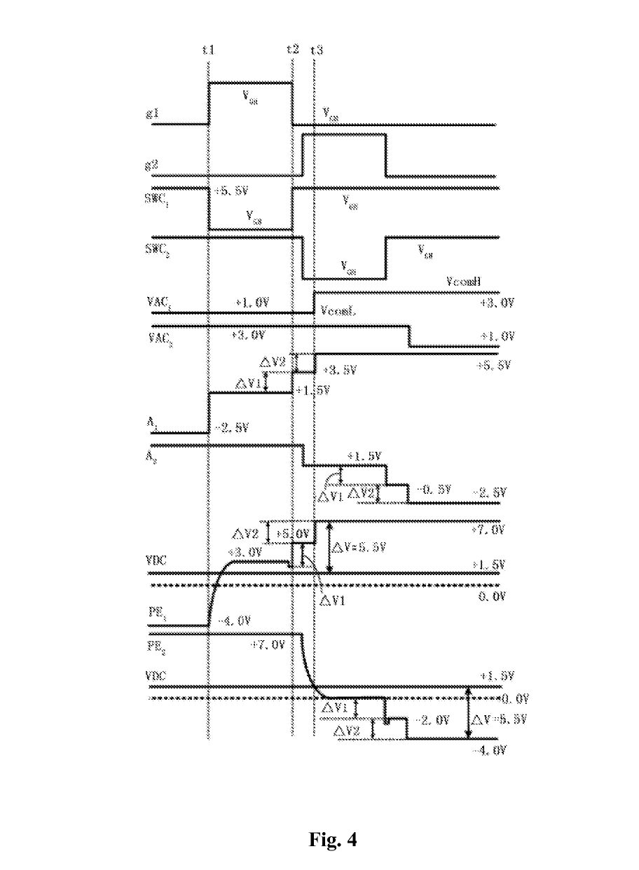

### DETAILED DESCRIPTION OF THE INVENTION

Certain embodiments are described in detail hereinafter, and examples of the embodiments are shown in the drawings. Throughout the text, the same or similar reference numeral generally indicate the same or similar elements or elements having the same or similar function. The embodiments described below with reference to the drawings are exemplary, which are only used to explain certain aspects and should not be understood as limiting the invention to the specific examples described.

These and other aspects of the embodiments of the invention will be clear with reference to the following description and drawings. In these description and drawings, some specific implementations of the embodiments are disclosed, indicating various ways of implementing the principles of the embodiments. It should be understood that the scope of the embodiments of the invention is not limited thereto. In contrast, embodiments of the invention include variations, modifications and equivalents which fall within the scope of the spirit and connotation of the described embodiments.

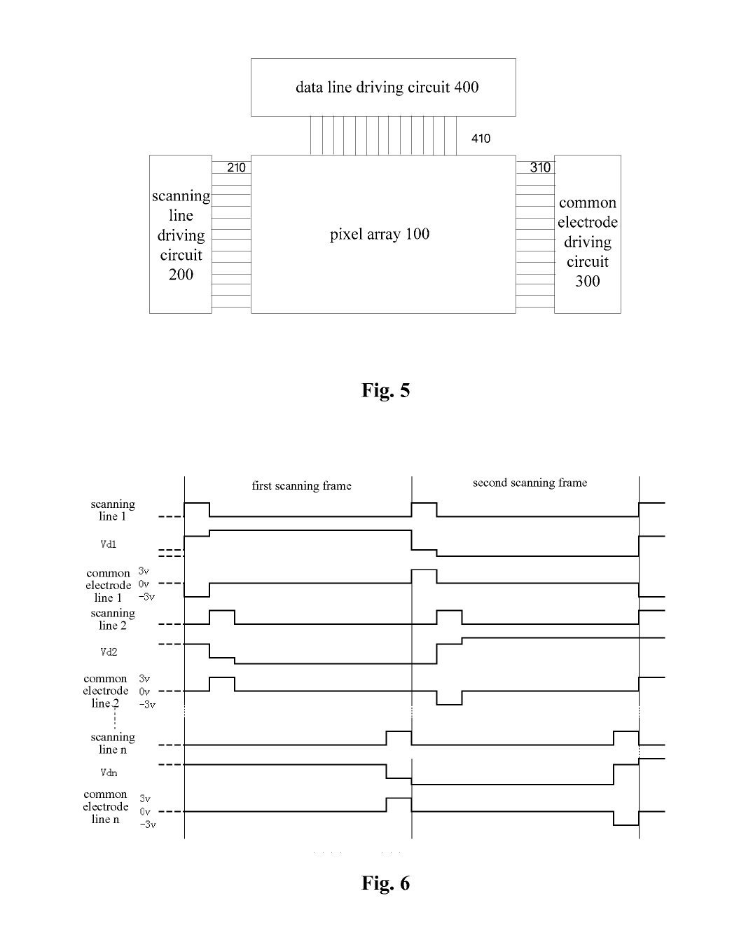

FIG. 5 is a schematic diagram of an LCD panel according to an embodiment. The LCD panel includes a pixel array 100, a scanning line driving circuit 200, a common electrode driving circuit 300 and a data line driving circuit 400. The pixel array 100 includes multiple pixels which are generally arranged in a rectangular array. The scanning line driving circuit 200 is connected to the pixel array 100 through multiple scanning lines 210, in which each of the multiple scanning lines 210 is connected to a row of pixels in the pixel array and is adapted to apply scanning signals to rows in the pixel array in sequence. In an embodiment, a row of pixels is selected if the scanning signal is high. The common electrode driving circuit 300 is connected to the pixel array 100 through multiple common electrode lines 310, in which each of the multiple electrode lines 310 is connected to a row of pixels in the pixel array 100 and is adapted to apply common electrode signals to rows in the pixel array 100 in sequence.

In an embodiment, each row of pixels is connected to a common electrode line 310, so as to ensure that the common electrode signal Vcom of each row is fixed, independent, and is not effected by activity of other rows. Thus, the problem of poor picture quality caused by the current line inversion can be avoided.

The data line driving circuit 400 is connected to the pixel array 100 through multiple data lines 410, and each of the multiple data lines 410 is connected to a column of pixels in the pixel array 100 and is adapted to apply a data signal to a column of the pixel array. Generally, the data signal applied by the data line 410 and the common electrode signal Vcom applied by the common electrode line 310 are opposite. For example, if the data signal is a negative data signal, the common electrode signal Vcom is usually a high level common electrode signal, so as to achieve an input of the selected pixel. In contrast, if the data signal is a positive data signal, the common electrode signal Vcom is usually a low level common electrode signal.

FIG. 6 is a timing sequence diagram of scanning lines, common electrode lines and data lines according to an embodiment. As shown in FIG. 6, during a current scanning frame, the scanning line driving circuit 200 controls the scanning lines 210 to output scanning signals in a corresponding time window in sequence. In each scanning frame, all the rows of the pixel array 100 are scanned, and the time corresponding to the scanning of each row is the corresponding time window. For example, the scanning line driving circuit 200 can control a first scanning line to output a scanning signal during a first time window, such as outputting a high level signal during the first time window; then the scanning line driving circuit 200 can control a second scanning line to output a scanning signal in a second time window, such as outputting a high level signal in the second time window, and so on. This may continue until all of the scanning lines are scanned. Herein the high level effective and the low level ineffective is a nonlimiting example. In other embodiments, the high level may be ineffective and the low level may be effective.

In an embodiment of the invention, during the current scanning frame, the common electrode driving circuit 300 controls each common electrode line to output common electrode signals in a time window in which the scanning line corresponding to the common electrode line outputs a scanning signal, and the common electrode signals output by the adjacent common electrode lines are opposite. In some embodiments, the term “opposite” refers to a relative high or low level of electrode signal, for example, a high level common electrode signal is opposite to a low level common electrode signal. In this way, a positive or negative voltage can be applied to the pixels by a voltage difference between the both common electrode signals. In some embodiments, the high level and the opposite low level are relative, as long as there is a voltage difference therebetween. For example, both the high level and the low level can be positive levels or negative levels. In some embodiments, the high level is a positive level, and the low level is a negative level. For example, the first common electrode is controlled to output a high level during the first time window, the second common electrode is controlled to output a low level during the second time window, and the first common electrode is controlled to be reset to and initializing signal during the time outside the corresponding time window. In an embodiment, the initializing signal is, for example, 0V. That is to say, the first common electrode line maintains the initializing signal for times outside the first time window, and outputs the low level in the first time window. Specifically, in an embodiment, the initial state of the common electrode lines is approximately 0V, the low level of the common electrode lines is approximately −3V, and the high level of the common electrode lines is approximately 3V, as shown in FIG. 6. In an embodiment, the level of the common electrode signal in the initial state is lower than that of the high level common electrode signal, but is higher than that of the low level common electrode signal. Accordingly, the level of the common electrode signal is between the levels of the high level common electrode signal and the low level common electrode signal.

In an embodiment, in the current scanning frame, the data line driving circuit 400 controls data lines 410 to output data signals during each time window in which the scanning lines output the scanning signal. The data signals applied to the adjacent rows of pixels have opposite polarities. In the embodiment, the term “opposite polarity” means that due to the different data signals of the adjacent pixels, a sign of a voltage difference between a data signal of a pixel and a common electrode signal corresponding the pixel is opposite to a sign of a voltage difference between a data signal of an adjacent pixel and a common electrode signal corresponding to the adjacent pixel. If the voltage difference between the data signal of a certain pixel and the electrode signal corresponding to the pixel is a positive value, the data signal is positive, and if the voltage difference between the data signal of a certain pixel and the common electrode signal corresponding to the pixel is a negative value, the data signal is negative. For example, if the first common electrode outputs a positive level common electrode signal, and each of the data signals applied to the first row of pixels is a negative level data signal, the negative level data signals output by the multiple data lines 410 are negative data signals. If the first common electrode outputs a negative level common electrode signal, and each of the data signals applied to the first row of pixels is a positive level data signal, the positive level data signals output by the multiple data lines 410 are positive data signals.

In the current scanning frame, the scanning line driving circuit 200 controls each of the scanning lines 210 to output a scanning signal in the corresponding time window in sequence, the common electrode driving circuit 300 controls the common electrode lines 310 to output a common electrode signal in a time window in which the scanning line corresponding to the common electrode line outputs the scanning signal, the adjacent common electrode lines output a high level common electrode signal and a low level common electrode signal respectively. In addition, the data line driving circuit 400 controls the multiple data lines 410 to output data signals during each time window in which the scanning lines output the scanning signal, and the data signals applied to the adjacent rows of pixels are respectively a positive data signal and a negative data signal. The common electrode signal output by the common electrode line in the adjacent scanning frame is opposite to that in the current scanning frame, and the data signals applied to the row of pixels in the adjacent scanning frame have opposite polarities to that in the current scanning frame, so as to achieve the line inversion.

The scanning for the next scanning frame starts after the scanning for the current scanning frame is finished. Specifically, during the next scanning frame, the scanning line driving circuit 200 controls the multiple scanning lines 210 to output scanning signals in the corresponding time window in sequence. In addition, the common electrode driving circuit 300 controls the common electrode line 310 to output a common electrode signal in a time window in which the scanning line corresponding to the common electrode line outputs the scanning signal. The common electrode signals output by the adjacent common electrode lines 310 are opposite, and the common electrode signal output by the common electrode line 310 in the next scanning frame is opposite to the common electrode signal output previously (i.e. in the current scanning frame described above). Accordingly, the data line driving circuit 400 controls the multiple data lines to output data signals during each time window in which the scanning line outputs the scanning signal. In addition, the data signals applied to the adjacent rows of pixels have opposite polarities, and the data signal applied to each row of pixels in the next scanning frame is opposite to that applied previously (i.e. in the current scanning frame described above), so as to achieve the line inversion. The steps for applying a scanning signal, a common electrode signal and a data signal is described in detail in the following embodiments.

According to certain embodiments, different displaying architectures such as IPS, AFFS, TN and VA can be compatible. In an embodiment, the IPS or AFFS architecture is applied to the LCD panel, and a common electrode of each row of pixels in the pixel array 100 is arranged on a TFT substrate, in which the multiple common electrode lines are respectively connected to the common electrode.

In another embodiment, the TN or VA structure is applied to the LCD panel, and a first common electrode of each row of pixels in the pixel array is arranged on the TFT substrate. In addition, a second common electrode of each row of pixels in the pixel array is arranged on a CF substrate, in which the multiple common electrode lines are connected to the first common electrode. Each of the second common electrodes is connected to a fixed electric potential, so as to achieve the above-described scheme.

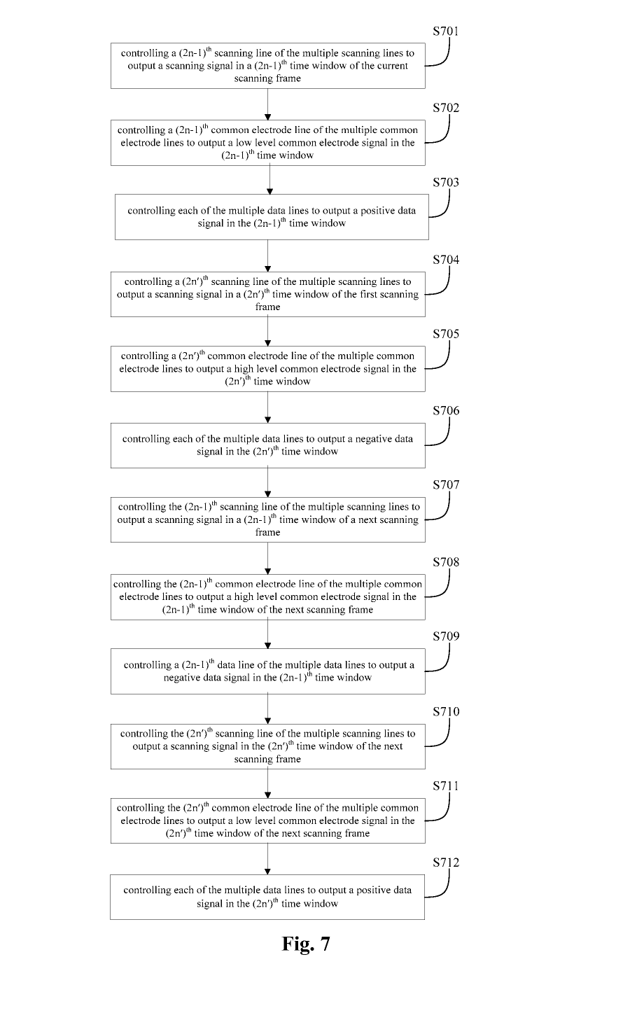

FIG. 7 is a flowchart of a driving method for an LCD panel according to an embodiment. In order to understand the discussed embodiments, details are discussed with reference to FIG. 6, but it should be noted that the order relationship between the steps are not limited by this specific example. The method includes the following steps.

Step S701 includes controlling a (2n−1)^{th} scanning line to output a scanning signal during a (2n−1)^{th} time window of the current scanning frame, where 2n−1≦N, n is a positive integer, and the pixel array has N rows of pixels. For example, referring to FIG. 6, a first scanning line outputs a scanning signal during a first time window of the current scanning frame.

Step S702 includes controlling a (2n−1)^{th} common electrode line to output a low level common electrode signal (for example, a negative level common electrode signal, such as −3V) during the (2n−1)^{th} time window, in which the row of pixels, connected to the (2n−1)^{th} scanning line, is further connected to the (2n−1)^{th} common electrode line. For example, referring to FIG. 6, the first common electrode line outputs a low level common electrode signal (such as a common electrode signal of −3V) during the first time window of the current scanning frame. For example, in the same way, as described above, a high level common electrode signal (which can be a positive level common electrode signal, such as 3V) can be output during the (2n−1)^{th}time window.

Step S703 includes controlling each of the multiple data lines to output a positive data signal during the (2n−1)^{th} time window. If a negative level common electrode signal is output during the (2n−1)^{th}time window in step S702, each of the multiple data lines outputs a positive level data signal during the (2n−1)^{th} time window in step S703. In this way, the output of the positive data signal can be ensured.

In addition, in the embodiment, if during step S702, a high level common electrode signal is output during the (2n−1)^{th} time window, during step S703 each of the multiple data lines outputs a negative data signal during the (2n−1)^{th} time window. In the same way, if during step S702 a positive level common electrode signal is output during the (2n−1)^{th} time window, during step S703 each of the multiple data lines outputs a negative level data signal during the (2n−1)^{th} time window, which can ensure that the output data signal is a negative data signal.

In the embodiments, for the TN and VA displaying architectures, the second common electrodes on the CF substrate can be connected to a fixed voltage, or can be grounded. The first common electrodes are connected to the above-described multiple common electrode lines according to the embodiments. In the embodiments, since the common electrode line can provide two types of voltage levels: a high voltage level and a low voltage level, and the voltage of the CF substrate is fixed (such as being grounded), the pixels of the TN and VA displaying architecture can be charged. In addition, since the capacitor in parallel with the pixel is also charged (by the data signal and the common electrode signal), and the voltage difference between the data signal and the common electrode signal is larger than the voltage difference between the common electrode signal and the CF substrate voltage, the voltage of the pixel is increased according to the principle of charge conservation, thus achieving the writing of the pixels of the TN and VA displaying architecture.

Step S704 includes controlling a (2n′)^{th} scanning line of the multiple scanning lines to output a scanning signal during a (2n′)^{th} time window of the current scanning frame, where 2n′≦N, n′ is a positive integer. Preferably, the (2n−1)^{th} scanning line is adjacent to the (2n′)^{th} scanning line. For example, referring to FIG. 6, the second scanning line outputs a scanning signal (such as a high level) in the second time window of the current scanning frame. Additionally, the scanning signal of the first scanning line is controlled to be reset (for example, reset to a low level).

Step S705 includes controlling a (2n′)^{th} common electrode line of the multiple common electrode lines to output a high level common electrode signal (which can be a positive level common electrode signal, such as 3V) during the (2n′)^{th} time window, in which the row of pixels, connected to the (2n′)^{th} scanning line, is further connected to the (2n′)^{th} common electrode line. For example, referring to FIG. 6, the second common electrode line outputs a high level common electrode signal, such as a common electrode signal of 3V, during the second time window of the current scanning frame. During a time outside the first time window, the common electrode signal of the first common electrode line is controlled to reset to the initial state, for example, 0V. In the embodiment, if a high level common electrode signal is output during the (2n−1)^{th} time window in step S702, a low level common electrode signal is output during step S705.

Step S706 includes controlling each of the multiple data lines to output a negative data signal during the (2n′)^{th} time window. If a positive level common electrode signal is output during the (2n′)^{th} time window in step S705, each of the multiple data lines outputs a negative level data signal in the (2n′)^{th} time window during step S706. In this way, the output of a negative data signal can be ensured.

In addition, in the embodiment, if a low level common electrode signal is output during the (2n′)^{th} time window in step S705, each of the multiple data lines outputs a positive data signal during the (2n′)^{th} time window in step S706. In the same way, if a negative level common electrode signal is output during the (2n′)^{th} time window during step S705, each of the multiple data lines outputs a positive level data signal during the (2n−1)^{th} time window during step S706. In this way, the output of a positive data signal can be ensured.

Step S707 includes controlling the (2n−1)^{th} scanning line of the multiple scanning lines to output a scanning signal during a (2n−1)^{th} time window of a next scanning frame, where 2n−1≦N, n is a positive integer, and the pixel array has N rows of pixels. For example, referring to FIG. 6, a first scanning line is controlled to output a scanning signal during a first time window of the next scanning frame.

Step S708 includes controlling the (2n−1)^{th} common electrode line of the multiple common electrode lines to output a high level common electrode signal (which can be a positive level common electrode signal) during the (2n−1)^{th} time window of the next scanning frame. In this way, for the same common electrode line, the common electrode signal in the current scanning frame is opposite to that in the next scanning frame. For example, referring to FIG. 6, the first common electrode line outputs a high level common electrode signal, such as a common electrode signal of 3V, during the first time window of the next scanning frame. For example, in the same way as described above, in the embodiment, a low level common electrode signal (which can be a negative level common electrode signal, such as −3V) can be output during the (2n−1)^{th} time window.

Step S709 includes controlling each of the multiple data lines to output a negative data signal during the (2n−1)^{th} time window. In this way, for the same row of pixels, the data signals of the current scanning frame and the next scanning frame have opposite polarities.

If a positive level common electrode signal is output during the (2n−1)^{th} time window during step S708, each of the multiple data lines outputs a negative level data signal during the (2n−1)^{th} time window during step S709. In this way, the output of the negative data signal can be ensured.

In addition, in the embodiment, if a low level common electrode signal is output during the (2n−1)^{th} time window in step S708, each of the multiple data lines outputs a positive data signal during the (2n−1)^{th} time window in step S709. In the same way, if a negative level common electrode signal is output during the (2n−1)^{th} time window in step S708, each of the multiple data lines outputs a positive level data signal during the (2n−1)^{th} time window during step S709. In this way, the output of the positive data signal can be ensured.

Step S710 includes controlling the (2n′)^{th} scanning line of the multiple scanning lines to output a scanning signal during the (2n′)^{th} time window of the next scanning frame, where 2n′≦N, n′ is a positive integer. For example, referring to FIG. 6, the second scanning line outputs a scanning signal (such as a high level) during the second time window of the next scanning frame. At this time, the scanning signal of the first scanning line is controlled to reset (for example reset to a low level).

Step S711 includes controlling the (2n′)^{th} common electrode line of the multiple common electrode lines to output a low level common electrode signal (which can be a negative level common electrode signal) during the (2n′)^{th} time window of the next scanning frame. For example, referring to FIG. 6, the second common electrode line outputs the low level common electrode signal, such as the common electrode signal of −3V, during the second time window of the next scanning frame. At this time (i.e. in the time except the first time window), the common electrode signal of the first common electrode line is controlled to reset to the initial state, i.e. 0V. In the embodiment, if a low level common electrode signal is output during the (2n−1)^{th} time window in step S708, a high level common electrode signal is output during step S711.

Step S712 includes controlling each of the multiple data lines to output a positive data signal during the (2n′)^{th} time window. If a negative level common electrode signal is output during the (2n′)^{th} time window in step S711, each of the multiple data lines outputs a positive level data signal during the (2n′)^{th} time window during step S712. In this way, the output of the positive data signal can be ensured.

In addition, in the embodiment, if a high level common electrode signal is output during the (2n′)^{th} time window in step S711, each of the multiple data lines outputs a negative data signal during the (2n′)^{th} time window during step S712. In the same way, if a positive level common electrode signal is output during the (2n′)^{th} time window during step S711, each of the multiple data lines outputs a negative level data signal during the (2n−1)^{th} time window in step S712. In this way, the output of the negative data signal can be ensured.

The embodiments of the invention also provide an LCD device with an LCD panel and a driving device, where the LCD panel is described above, and the driving device is a device for driving the LCD panel as described above.

According to some embodiments, different displaying architectures such as IPS, AFFS, TN and VA can be compatible, and a function similar to the line inversion can be achieved. In the embodiments, the common electrode signal corresponding to each row of pixels may be fixed, so as to avoid the problem of poor display quality caused by the line inversion.

As used herein, the terms “an embodiment,” “some embodiments,” “an example,” “specific example,” and “some examples” are intended to indicate that the specific features, structures, materials or other characteristics described in conjunction with the embodiment or the example are included in at least one embodiment or example. In the specification, the schematic description of the above-described terms is not necessary to refer to the same embodiment or example. Furthermore, the described specific features, structures, materials or characteristics can be combined in an appropriate way in any one or more embodiments or examples.

Although specific embodiments have been illustrated and described, those skilled in the art can understand that numerous changes, modifications, alternatives and variations can be made to these embodiments without deviating from the principle and aim of the invention.

What is claimed is:

1. A Liquid Crystal Display (LCD) panel, comprising:
a pixel array comprising:
a plurality of pixels, arranged in rows and columns,
a plurality of scanning lines, wherein each of the scanning lines is connected to one of the rows of pixels in the pixel array,
a plurality of common electrode lines, wherein each of the common electrode lines is connected to one of the rows of pixels in the pixel array, and
a plurality of data lines, wherein each of the data lines is connected to a column of pixels in the pixel array;
a scanning line driving circuit connected to the scanning lines of the pixel array and configured to apply a scanning signal to each row of pixels;
a common electrode driving circuit connected to the common electrode lines of the pixel array and configured to apply a common electrode signal to each row of pixels; and
a data line driving circuit connected to the data lines of the pixel array and configured to apply a data signal to each column of pixels in the pixel array,
wherein during a first scanning frame, the scanning line driving circuit sequentially applies a scanning signal to each of the scanning lines during a corresponding time window, wherein the common electrode driving circuit applies a common electrode signal to each common electrode line during a time window in which the scanning signal is applied to the corresponding scanning line, wherein the common electrode signals applied to adjacent common electrode lines are opposite, and wherein the data line driving circuit applies data signals to the plurality of data lines during a time window in which the scanning signal is applied to one of the scanning lines, and the data signals applied to adjacent rows of pixels have opposite polarities, and
wherein the common electrode signal output by the common electrode line during the first scanning frame is opposite the common electrode signal output during a next scanning frame, and the data signals of the row of pixels during the first scanning frame have opposite polarities to the data signals of the row of pixels during the next scanning frame.

2. The LCD panel according to claim 1, wherein adjacent common electrode lines are respectively applied with a high level common electrode signal and a low level common electrode signal, and the data signals applied to the adjacent rows of pixels are a positive data signal and a negative data signal, respectively.

3. The LCD panel according to claim 2, wherein
the scanning line driving circuit applies a (2n−1)^{th} scanning line with a scanning signal in a (2n−1)^{th} time window of the first scanning frame, wherein 2n−1≦N, n is a positive integer, and the pixel array has N rows of pixels;
the common electrode driving circuit applies a low level common electrode signal to a (2n−1)^{th} common electrode line during the (2n−1)^{th} time window, wherein the row of pixels connected to the (2n−1)^{th} scanning line is also connected to the (2n−1)^{th} common electrode line;
the data line driving circuit applies the positive data signal to each of the plurality of data lines during the (2n−1)^{th} time window;
the scanning line driving circuit applies a scanning signal to a (2n′)^{th} scanning line during a (2n′)^{th} time window of the first scanning frame, wherein 2n′≦N, n′ is a positive integer;
the common electrode driving circuit applies a high level common electrode signal to a (2n′)^{th} common electrode line during the (2n′)^{th} time window, wherein the row of pixels connected to the (2n′)^{th} scanning line is also connected to the (2n′)^{th} common electrode line; and
the data line driving circuit applies the negative data signal to each of the plurality of data lines during the (2n′)^{th} time window.

4. The LCD panel according to claim 3, wherein
the scanning line driving circuit applies a scanning signal to the (2n−1)^{th} scanning line during a (2n−1)^{th} time window of the next scanning frame;
the common electrode driving circuit applies the high level common electrode signal to the (2n−1)^{th} common electrode line of the plurality of common electrode lines during the (2n−1)^{th} time window of the next scanning frame;
the data line driving circuit applies the negative data signal to the (2n−1)^{th} data line during the (2n−1)^{th} time window;
the scanning line driving circuit applies a scanning signal to the (2n′)^{th} scanning line during a (2n′)^{th} time window of the next scanning frame;
the common electrode driving circuit applies the low level common electrode signal to the (2n′)^{th} common electrode line during the (2n′)^{th} time window of the next scanning frame; and
the data line driving circuit applies the positive data signal to each of the plurality of data lines during the (2n′)^{th} time window.

5. The LCD panel according to claim 2, wherein
the scanning line driving circuit applies a scanning signal to a (2n−1)^{th} scanning line during a (2n−1)^{th} time window of the current scanning frame, wherein 2n−1≦N, n is a positive integer, and the pixel array has N rows of pixels;
the common electrode driving circuit applies the high level common electrode signal to a (2n−1)^{th} common electrode line during the (2n−1)^{th} time window, wherein the row of pixels connected to the (2n−1)^{th} scanning line is further connected to the (2n−1)^{th} common electrode line;
the data line driving circuit applies the negative data signal to each of the plurality of data lines during the (2n−1)^{th} time window;
the scanning line driving circuit applies a scanning signal to a (2n′)^{th} scanning line during a (2n′)^{th} time window of the current scanning frame, wherein 2n′≦N, n′ is a positive integer;
the common electrode driving circuit applies the low level common electrode signal to a (2n′)^{th} common electrode line during the (2n′)^{th} time window, wherein the row of pixels connected to the (2n′)^{th} scanning line is further connected to the (2n′)^{th} common electrode line; and
the data line driving circuit applies the positive data signal to each of the plurality of data lines during the (2n′)^{th} time window.

6. The LCD panel according to claim 5, wherein
the scanning line driving circuit applies a scanning signal to the (2n−1)^{th} scanning line during a (2n−1)^{th} time window of the next scanning frame;
the common electrode driving circuit applies the low level common electrode signal to the (2n−1)^{th} common electrode line during the (2n−1)^{th} time window of the next scanning frame;
the data line driving circuit applies a positive data signal to the (2n−1)^{th} data line during the (2n−1)^{th} time window;
the scanning line driving circuit applies a scanning signal to the (2n′)^{th} scanning line during the (2n′)^{th} time window of the next scanning frame;
the common electrode driving circuit applies the high level common electrode signal to the (2n′)^{th} common electrode line during the (2n′)^{th} time window of the next scanning frame; and
the data line driving circuit applies the negative data signal to each of the plurality of data lines during the (2n′)^{th} time window.

7. The LCD panel according to claim 2, wherein the high level common electrode signal has a positive polarity, and the low level common electrode signal has a negative polarity.

8. The LCD panel according to claim 7, wherein the positive data signal has a positive polarity, and the negative data signal has a negative polarity.

9. The LCD panel according to claim 2, wherein the common electrode driving circuit applies an initializing signal to each of the common electrode lines during a time outside the corresponding time window.

10. The LCD panel according to claim 9, wherein the initializing signal is 0 Volt.

11. The LCD panel according to claim 2, wherein an In-Plane Switching structure or an Advanced Fringe Field Switching structure is applied to the LCD panel, and a common electrode for a row of pixels in the pixel array is arranged on a Thin Film Transistor substrate, and wherein the plurality of common electrode lines are respectively connected to the common electrode.

12. The LCD panel according to claim 2, wherein a Twisted Nematic structure or a Vertical Alignment structure is applied to the LCD panel, and a first common electrode for a row of pixels in the pixel array is arranged on a TFT substrate, a second common electrode for a row of pixels in the pixel array is arranged on a Color Filter substrate, and wherein the plurality of common electrode lines are respectively connected to the first common electrode, and the second common electrode is connected to a fixed electric potential.

13. A method of driving a Liquid Crystal Display (LCD), panel, wherein the LCD panel comprises a pixel array, a plurality of scanning lines and a plurality of common electrode lines connected to rows of pixels in the pixel array, and a plurality of data lines connected to columns of pixels in the pixel array, wherein the method comprises:
applying a scanning signal during a (2n−1)^{th} time window of a current scanning frame to a (2n−1)^{th} scanning line, wherein 2n−1≦N, n is a positive integer, and the pixel array has N rows of pixels;
applying a low level common electrode signal to (2n−1)^{th} common electrode line during the (2n−1)^{th} time window, wherein the row of pixels connected to the (2n−1)^{th} scanning line is also connected to the (2n−1)^{th} common electrode line;
applying a positive data signal to each of the plurality of data lines during the (2n−1)^{th} time window;
applying a scanning signal to a (2n′)^{th} scanning line during a (2n′)^{th} time window of the current scanning frame, wherein 2n′≦N, n′ is a positive integer;
applying a high level common electrode signal to a (2n′)^{th} common electrode line during the (2n′)^{th} time window, wherein a row of pixels connected to the (2n′)^{th} scanning line is also connected to the (2n′)^{th} common electrode line; and
applying a negative data signal to each of the plurality of data lines during the (2n′)^{th} time window.

14. The driving method of the LCD panel according to claim 13, further comprising:
applying a scanning signal to the (2n−1)^{th} scanning line during a (2n−1)^{th} time window of the next scanning frame;
applying the high level common electrode signal to the (2n−1)^{th} common electrode line during the (2n−1)^{th} time window of the next scanning frame;
applying the negative data signal to the (2n−1)^{th} data line during the (2n−1)^{th} time window;
applying a scanning signal to the (2n′)^{th} scanning line during a (2n′)^{th} time window of the next scanning frame;
applying the low level common electrode signal to the (2n′)^{th} common electrode line during the (2n′)^{th} time window of the next scanning frame; and
applying the positive data signal to each of the plurality of data lines during the (2n′)^{th} time window.

15. The driving method of the LCD panel according to claim 13, wherein the high level common electrode signal has a positive polarity, and the low level common electrode signal has a negative polarity.

16. The driving method of the LCD panel according to claim 15, wherein the positive data signal as a positive polarity, and the negative data signal has a negative polarity.

17. The driving method of the LCD panel according to claim 13, further comprising:
applying an initializing signal to each of the common electrode lines during a time outside the corresponding time window.

18. The driving method of the LCD panel according to claim 17, wherein the initializing signal is 0 Volt.

19. The driving method of the LCD panel according to claim 13, wherein an In-Plane Switching structure or an Advanced Fringe Field Switching structure is applied to the LCD panel, and the common electrode for a row of pixels in the pixel array is arranged on a Thin Film Transistor substrate, and wherein the plurality of common electrode lines are connected to the common electrode.

20. The driving method of the LCD panel according to claim 13, wherein a Twisted Nematic structure or a Vertical Alignment structure is applied to the LCD panel, and a first common electrodes for a row of pixels in the pixel array is arranged on a TFT substrate, a second common electrode for a row of pixels in the pixel array is arranged on a Color Filter substrate, and wherein the plurality of common electrode lines are connected to the first common electrode, and the second common electrode is connected to a fixed electric potential.

21. A method of driving a Liquid Crystal Display (LCD) panel, wherein the LCD panel comprises a pixel array, a plurality of scanning lines and a plurality of common electrode lines connected to rows of pixels in the pixel array, and a plurality of data lines connected to columns of pixels in the pixel array, wherein the method comprises:
applying a scanning signal to a (2n−1)^{th} scanning line during a (2n−1)^{th} time window of a current scanning frame, wherein 2n−1≦N, n is a positive integer, and the pixel array has N rows of pixels;
applying a high level common electrode signal to a (2n−1)^{th} common electrode line during the (2n−1)^{th} time window, wherein the row of pixels connected to the (2n−1)^{th} scanning line is also connected to the (2n−1)^{th} common electrode line;
applying a negative data signal to each of the plurality of the data lines during the (2n−1)^{th} time window;
applying a scanning signal to a (2n′)^{th} scanning line during a (2n′)^{th} time window of the current scanning frame, wherein 2n′≦N, and n′ is a positive integer;
applying a low level common electrode signal to a (2n′)^{th} common electrode line during the (2n′)^{th} time window, wherein the row of pixels connected to the (2n′)^{th} scanning line is also connected to the (2n′)^{th} common electrode line; and
applying a positive data signal to each of the plurality of data lines during the (2n′)^{th} time window.

22. The driving method of the LCD panel according to claim 21, further comprising:
applying a scanning signal to the (2n−1)^{th} ′ scanning line during a (2n−1)^{th} time window of a next scanning frame;
applying the low level common electrode signal to the (2n−1)^{th} common electrode line during the (2n−1)^{th} time window of the next scanning frame;
applying the positive data signal to the (2n−1)^{th} data line during the (2n−1)^{th} time window;
applying a scanning signal to the (2n′)^{th} scanning line during a (2n′)^{th} time window of the next scanning frame;
applying the high level common electrode signal to the (2n′)^{th} common electrode line during the (2n′)^{th} time window of the next scanning frame; and
applying a negative data signal to each of the plurality of data lines during the (2n′)^{th} time window.

23. The driving method of the LCD panel according to claim 21, wherein the high level common electrode signal has a positive polarity, and the low level common electrode signal has a negative polarity.

24. The driving method of the LCD panel according to claim 23, wherein the positive data signal has a positive polarity, and the negative data signal has a negative polarity.

25. The driving method of the LCD panel according to claim 21, further comprising:
applying and initializing signal to each of the common electrode lines during a time outside corresponding time window.

26. The driving method of the LCD panel according to claim 25, wherein the initializing signal is 0 Volt.

27. The driving method of the LCD panel according to claim 21, wherein an In-Plane Switching structure or an Advanced Fringe Field Switching structure is applied to the LCD panel, and a common electrode for a row of pixels in the pixel array is arranged on a Thin Film Transistor substrate, and wherein the plurality of common electrode lines are connected to the common electrode.

28. The driving method of the LCD panel according to claim 21, wherein a Twisted Nematic structure or a Vertical Alignment structure is applied to the LCD panel, and a first common electrode for a row of pixels in the pixel array is arranged on a Thin Film Transistor substrate, a second common electrode for a row of pixels in the pixel array is arranged on a Color Filter substrate, and wherein the plurality of common electrode lines are connected to the first common electrode, and the second common electrode is connected to a fixed electrical potential.

29. A liquid crystal display device, comprising:
a Liquid Crystal Display (LCD) panel, comprising:
a pixel array comprising:
a plurality of pixels, arranged in rows and columns,
a plurality of scanning lines, wherein each of the scanning lines is connected to one of the rows of pixels in the pixel array,
a plurality of common electrode lines, wherein each of the common electrode lines is connected to one of the rows of pixels in the pixel array, and
a plurality of data lines, wherein each of the data lines is connected to a column of pixels in the pixel array;
a scanning line driving circuit connected to the scanning lines of the pixel array and configured to apply a scanning signal to each row of pixels;
a common electrode driving circuit connected to the common electrode lines of the pixel array and configured to apply a common electrode signal to each row of pixels; and
a data line driving circuit connected to the data lines of the pixel array and configured to apply a data signal to each column of pixels in the pixel array,
wherein during a first scanning frame, the scanning line driving circuit sequentially applies a scanning signal to each of the scanning lines during a corresponding time window, wherein the common electrode driving circuit applies a common electrode signal to each common electrode line during a time window in which the scanning signal is applied to the corresponding scanning line, wherein the common electrode signals applied to adjacent common electrode lines are opposite, and wherein the data line driving circuit applies data signals to the plurality of data lines during a time window in which the scanning signal is applied to one of the scanning lines, and the data signals applied to adjacent rows of pixels have opposite polarities, and
wherein the common electrode signal output by the common electrode line during the first scanning frame is opposite the common electrode signal output during a next scanning frame, and the data signals of the row of pixels during the first scanning frame have opposite polarities to the data signals of the row of pixels during the next scanning frame.
